(19) United States
(12) Patent Application Publication
(10) Pub. No.: US 2011/0010656 A1
(43) Pub. Date: Jan. 13, 2011

(54) APPARATUS AND METHOD FOR IMPROVED USER INTERFACE

(75) Inventor: Michael S. MOKOTOV, Tel Aviv (IL)

Correspondence Address: SOROKER-AGMON ADVOCATE AND PATENT ATTORNEYS, NOLTON HOUSE, 14 SHENKAR STREET, HERZELIYA PITUACH, 46725, IL

(73) Assignee: Ta Keo Ltd, Tel Aviv (IL)

(21) Appl. No.: 12/501,504

(22) Filed: Jul. 13, 2009

(51) Int. Cl. G06F 3/048

(52) U.S. Cl. 715/780; 715/862; 715/808

(57) ABSTRACT

A method and apparatus for receiving information from a user of a computerized application. Within the method, application data is received, comprising one or more items with which a user can interact. Additional data relating to the application may be received as well. The application data is displayed on a display device, while the additional data is kept hidden. Upon receiving mouse hover event from a pointing device used by a user, the additional data relating to the application is displayed, together with an area for a user to enter content. The content entered by the user is submitted to the application or to another application.

### TECHNICAL FIELD

The present disclosure relates to user interface of computerized systems in general, and to a method and apparatus for enhancing the efficiency and interactivity of user interfaces, in particular.

### BACKGROUND

Modern computer applications provide users with multiple ways for communicating and exchanging information, including for example c-mails, chat rooms, public internet forums, private internet forums, and others.

Similarly to other computerized systems, most of these communication applications provide graphic user interface (GUI) in order to provide the users with easy and intuitive access to the enables functionalities, including viewing data, entering data, communicating with peers.

Some of the systems, such as e-mail or internet forums may arrange the communication items as a list. In some systems, such as Outlook by Microsoft Corporations Ltd. of Redmond, Wash., USA, all items are on the same level, i.e. there is no hierarchy among items. In others, such as certain forum platforms, there is a hierarchy, so that an item (also referred to as a message or a post) may relate to a previously introduced post. In both types of systems, however, a user can relate to any of the previous messages, including a message which is in itself a response to yet another message, or add a new one.

The specific flow of events required for providing information in a communication system usually depends on the particular implementation. Generally, when relating to an existing item, for example replying to an e-mail message or posting a response to an existing post, the user has to select the item he is responding to, open the item, indicate that he would like to react and then use the provided interface for entering the response. The same sequence is required even for very short responses, such as yes/no response, so that the preceding and following actions take more time than the actual responding.

If a user wants to respond, comment, or otherwise react to a number of items, the multiplicity of required actions, and change of context may slow him or her, and even make him give up on responding to some of them. Providing a more efficient and easy to use interface may expedite the process and make the users more active.

The operators of such systems, such as the owner of a website, would also like the interface to be as convenient and efficient as possible, in order to provide a better service, make the user interact more with the site and increase the traffic volume in the site, or improve productivity in systems like emails, notes on reports, or the like.

On the other hand, a more efficient user interface should not limit the user in the types of information he or she can provide, and all existing functionality of the system should be maintained.

The same considerations are true for any system showing one or more items with which a user can interact.

There is thus a need in the art for a method and apparatus for enabling efficient operation of computerized systems, and in particular systems in which a user can respond to a multiplicity of items.

### SUMMARY

A message and apparatus for increasing the usability of a computerized application, by presenting a display container to a user, which displays some or all of the information associated with an item of the application, and in which the user can also add content which can be published.

A first aspect of the disclosure related to a method for receiving information from a user of a computerized application, comprising: receiving application data comprising one or more items to which a user can react; receiving additional data relating to the application; displaying on a display device the application data to a user using a pointing device; receiving an event indicating that the pointing device hovered over one of the items; displaying on the display device a display container displaying the additional data relating to the at least one item, and an area for a user to enter content; and submitting the content entered by the user. The method can further comprise a step of publishing the information submitted by the user. Within the method, the content provided by the user is optionally viewable by a human being. The method can further comprise determination of a location in which the display container is placed on the display device. Within the method, the location is optionally determined in accordance with one or more of the conditions selected from the group consisting of: no other item that invokes a hover event separates the item and the display container, the display container does not hide another item that invokes a hover event, the display container does not hide an important area of the application, and the display container is fully contained within the display device. Within the method, the location is optionally determined so that the additional data is fully viewable by the user. The method can further comprise locking the display container so that no further events indicating that the pointing device hovered over one of the items is handled. Within the method, the additional data optionally comprises at least part of the contents of one of the items. The method can further comprise generating the application data. The method can further comprise generating the additional data. Within the method, the application is optionally selected from the group consisting of: a forum, a discussion group or an online discussion service; a video, audio or photo uploading or sharing platform; a blog; a file sharing application; a social bookmarking applications, an e-mail application; a bookmarking application; a directory application, a search engine or a search service; a map application; a diagrams; a travel application; a retail or shopping application; a price comparison or marketplace application; a product review application; an educational application; a telecomm application; a business application; a financial application; a reporting application; an activity record application; a Customer Relationship Management (CRM) application; an Enterprise Resource Planning (ERP) application; a news item application; and a data feed handling application. Within the method, the additional data is optionally embedded and hidden within the application data.

Another aspect of the disclosure relates to an apparatus for receiving information from a user of a computerized application executed on a computing platform, comprising: a functionality providing component for providing application data and functionality associated with one or more items to which a user of the application can react; an additional data generation component for generating additional data related to the application and adding the additional data to the application data; and a window location determination component for determining a location on the display device at which a display container displaying the additional data and having an area for the user to enter content, is to be located. The apparatus can further comprise an additional data presentation component for displaying the display container on a display device, when a pointing device hovers over one of the items. Within the apparatus, the application is optionally a client-server application, and the server-side application comprises an additional data generation component for generating additional data related to the items and adding the additional data to the application data; and the client-side application comprises an additional data retrieval component for retrieving the additional data from the application data. Within the apparatus, the content provided by the user is optionally published. Within the apparatus, the content provided by the user is optionally viewable by a human being. Within the apparatus, the additional data optionally comprises at least a part of the contents of one of the items. Within the apparatus, the application is optionally selected from the group consisting of: a forum, a discussion group or an online discussion service; a video, audio or photo uploading or sharing platform; a blog; a file sharing application; a social bookmarking applications, an e-mail application; a bookmarking application; a directory application, a search engine or a search service; a map application: a diagrams; a travel application; a retail or shopping application; a price comparison or marketplace application; a product review application; an educational application; a telecomm application; a business application; a financial application; a reporting application; an activity record application; a Customer Relationship Management (CRM) application; an Enterprise Resource Planning (ERP) application; a news item application; and a data feed handling application.

Yet another aspect of the disclosure relates to a tangible computer readable storage medium containing a set of instructions for a general purpose computer, the set of instructions comprising: receiving application data relating to an application comprising one or more items to which a user can react; receiving additional data relating to one of the items; displaying on a display device the application data to a user using a pointing device; receiving an event indicating that the pointing device hovered over one of the items; displaying on the display device the additional data relating to the application, and an area for a user to enter content; and updating the application with the information entered by the user.

### BRIEF DESCRIPTION OF THE DRAWINGS

The present disclosure will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a schematic illustration of a screen shot of a web page comprising a forum, in accordance with the disclosure;

FIG. 2 is a schematic illustration of a second screen shot of a forum application in which a user responds, in accordance with the disclosure;

FIG. 3 is a schematic illustration of a screen shot of an e-mail application used by a user, in accordance with the disclosure;

FIG. 4 is a flow chart of the main step of a method for enabling a user to respond to multiple items, in accordance with the disclosure; and

FIG. 5 is a block diagram of an apparatus for enabling a user to respond to multiple items, in accordance with the disclosure.

### DETAILED DESCRIPTION

An apparatus and method for providing easy to use and efficient user interface, which enables a user to respond to one or more items presented by an application representing one or more data items of any type, such as an e-mail application, an internet forum, a blog, a data management system, an action list, a report, a map, a diagram, an online shop or any other site offering products, search results, a file sharing application or system, business applications, financial applications or any other systems in which users can submit replies, comments or notes to be read by themselves or by others, or the like. A user in such systems responds by adding content, such as but not limited to text, pictures, video, audio, or any other type of information.

The disclosure relates to an apparatus and method that make the user's interaction with an application faster, more convenient without changing the context or the web page the person is browsing, thus enabling the user to respond faster, or to respond to more items in a given time period, and without loosing the context. For example if a person is browsing a particular web page containing an item to which he can respond, after using the disclosed method and apparatus for responding, the browser is still displaying the same page and does not have to navigate back to it.

In graphical user interfaces, some areas of the display are defined as “controls”. When activity associated with a pointing device, such as mouse, joystick, touch screen or any other pointing device, is detected over the control, an event may be fired. Such event can be, for example, a “mouse down”, “mouse up”, “mouse enter”, “mouse leave”, “mouse over”, or others. Another such event is “hover” or “mouse hover”, which is fired when the mouse or another pointing device rests on the control for at least a predetermined period of Lime. A notification of a fired event is passed to a relevant handler, optionally with additional information such as the actual content to display, the location, user interface instructions how to display, or the like. The exact handling of the event depends on the underlying system, so different systems may require different data.

When a mouse hover event is received for a certain item, such as an e-mail or a forum message, a window, a frame, a div, or any other display container is opened which contains all or a preview of the content of the item if any is available, as well as an area for the user to enter content of his own. In cases where there is no initial data, such as when the mouse hovers over a “new item” button, then only an area for the user to enter content is displayed, optionally with a suitable title. The response area can receive the focus of the display container, so that the user can immediately start typing text into the window, without having to perform any more actions. Alternatively, the user will have to set the focus of the window at the data entering area, for example by clicking the mouse button. However, this will be required only if the user wished to enter data to the window. In some embodiments, if the original item is itself a response to another item, then the contents of the whole chain of items is optionally displayed in the window. Alternatively, it is possible to show any number of the most recent items of the chain, such as the latest five posts of the thread, or any portion thereof, such as the first five hundred characters of each of the last five posts. Optionally, in cases a chained communication is viewed or previewed, the chained items will be ordered, and the window will initially show the latest items. If a user wishes to see earlier posts, he can scroll within the preview section of the window. The input section of the window will not be affected and will remain viewable at all times.

If the user does not want to respond to the item, he or she can close the window or keep working with the application, which is not disabled. The user can also leave the window open and move the mouse such that a new mouse hover event is generated in association with another item. The window will then close and another window will open containing the contents of the new item, and enabling the user to view or respond to the new item. If the user explicitly indicated he wants to close the window, for example by clicking on a “close” button, the window will close. In some embodiments, the window can be located so that the “close” button is located as close as possible to the location of the mouse at the time the hover event was fired, so that if the user does not want to see the window, he will not have to move the mouse to a far location in order to close it. For example, if the window is opened to the left of the mouse, the close button will be located on the right hand side of the window.

The window can be dragged or otherwise moved by the user to any other location on the screen.

If the user does not respond to the items, the opened containers provide easy browsing capabilities and viewing or previewing for all items without having to click on any of them.

If the user initiates an action indicating he wishes to enter content, for example by placing the focus on an input field if the focus is not there by default, or by actually typing in any of the fields, the window will be locked, which means other display containers associated with the disclosure, such as other hidden windows will not open, and it will not close when the mouse hovers over other triggering areas, so as to avoid data loss. Optionally, the user will be asked whether he or she wishes to submit the contents or discard them. Optionally, if the user moved the window, for example by dragging, this can also indicate the user may wish to respond at a later time, and the window will be locked.

In some embodiments of e-mail applications, the opened container is a new e-mail window, containing the contents of the message for which the mouse hover event was received (the original message), and enabling the user to respond. The new e-mail may be started as a “reply” message to the original message, i.e., addressed to the sender of the message, as a “reply to all”, i.e., addressed to the sender of the message as well as to all other recipients including the user, or as with no recipient at all. In such embodiments, the window may comprise a “reply” control that will send the message to the original sender, a “reply to all” control that will send the message to the original sender as well as to all other recipients, or a “send” button” that will appear only after the user entered at least one recipient, whether in a “To”, “Cc”, or “Bcc” filed.

In some embodiments, the window may comprise all contents of the original item, including text, pictures, video that starts playing when the window is displayed, audio that starts playing when the window is displayed, or the like. In some embodiments, only portions of the contents may be presented such as a preview, the latest items of a chain, or the like, wherein the rest of the item can be presented upon request of the user, for example by using a corresponding control.

In some embodiments no information will be shown on the window, except for the input fields. For example, when one or more users' icons or pictures are shown, a mouse hover can indicate a desire to send a private message to the user whose picture triggered the mouse hover event.

The input to be submitted by the user may include one or more fields, of which one or more can be mandatory, such as an address in an e-mail. The data entry fields may include text fields, choosable input fields such as radio buttons or checkboxes, uploading of images, video, sound or any other file type, or any other type of input field available for the application.

The user can be provided with multiple controls, each initiating a different option to process the submitted data, such as a “reply” button and a “reply all” button in an e-mail application. In another example, in which users can interact with each other a user can be given multiple options to send the data: via email, via an instant messenger, via an SMS, via a Private Message on the site, by posting the message on the user profile page, by posting the submitted data to a different site, or by any other option.

If only one handling potion is available, such as posting a reply to a post in a forum, the window can comprise a single “submit” control, which when clicked or otherwise indicated, submits the content inserted by the user to the system.

When the information is submitted, an immediate notice to the user is optionally provided, indicating that the information is being processed. The indication may be textual or graphic, such as a rotating circle. Upon completion, the window is removed from the screen, a success notice is optionally shown to the user, and the screen is updated with the new information, if applicable, without being refreshed.

In order to determine a location for the response window, a number of constraints or preferences have to be met. First, the whole window should be viewable, i.e., no part of the window should exceed the display boundaries. If the content of the original item can not fit within such window, a scrollbar may be provided as part of the window. Alternatively, only some of the information is presented, thus providing a preview.

Yet another limitation relating to the location of the window, is that no item that causes a “mouse over” event to be fired must separate between the original item and the window. If this limitation is not met, the user may want to move the mouse so that it enters the window, but during the movement, the window will be closed and another window associated with the “separating item” will pop up.

The window should be located so as to avoid hiding any important elements of the underneath application. In addition, the window's location should be determined so as to avoid hiding other items causing a mouse hover event, thus allowing the user to browse through other items without having to close the window first.

The window should be “draggable” to allow the user to move it to a different location, for example if any required information is hidden by the window.

Additionally, the window should be opened relatively close to the item it shows, so that the user easily associates between the item and the window.

It will be appreciated that the disclosure can be used for any application that may receive data from a user, and in any manner associated with the application. The application may be implemented as an executable executed on the user's computing platform or on a remote platform, an online service, or any other system. The applications for which the disclosure may be used include but are not limited to: forums, discussion groups, or online discussion services in which a user may post new messages or reply to existing posts; video, audio, or photo uploading or sharing platforms, in which a user can post video or images, or provide comments or reviews on items; blogs in which a user can post blog posts or messages, or comment on items; file sharing applications, in which a user can share applications or provide comments or reviews on applications posted by others; email applications; social bookmarking applications in which a user can add new comments, share, or bookmark new items; bookmarking applications; directory applications in which a user can comment on items on a directory; a search engine or a search service providing search results, for which a user can provide comments or bookmark items; map applications in which a user can provide comments on locations, pictures, notes or other items; diagrams in which a user can provide comments on elements; travel applications, in which a user can provide reviews or comments, or make a booking; retail or shopping applications, in which a user can provide product reviews or comments, or make a purchase; price comparison or other marketplace applications in which a user can provide product reviews, comments, or seller reviews, or make a purchase; product review applications in which a user can provide product reviews or make a purchase; educational applications in which a user can provide notes on items; telecomm applications; business applications; financial applications; reporting applications or activity record applications in which a user can provide notes, questions, or comments on items; a Customer Relationship Management (CRM) or an Enterprise Resource Planning (ERP) applications in which a user can provide notes, questions, or comments on items; news items applications in which a user can provide talkbacks, notes or bookmark items; data feed handling applications, in which a user can provide notes or bookmark items, or any other application.

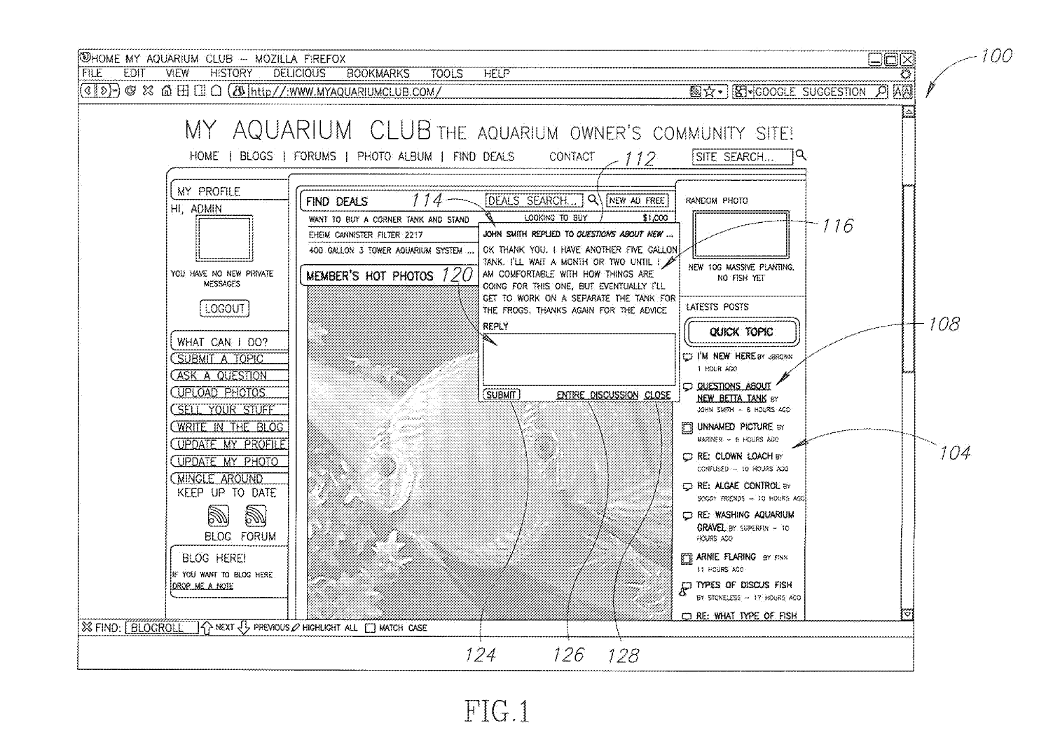

Referring now to FIG. 1, showing a schematic illustration of a screen shot of a web page comprising a forum, in accordance with the disclosure. The application, generally referenced 100 comprises a number of areas, including area 104 showing the titles of the latest activities on a virtual community site. The titles shown in area 104 relate to the newest threads or chained communications added, or chained communications to which new posts had been lately added. A user using a pointing device such as a mouse, joystick, touch screen or the like hovered over posts indicated in area 104, such as post 108. As a result and without any further action by the user, window 112 popped Up. Window 112 has a title 114 which relates to the title of post 108, an area 116 showing a full view or a partial preview of the content of post 108, or the entire or parts of the chain of communication post 108 belongs to, and area 120 for the user to enter new content, in this case as a response to post 108.

Window 112 further comprises “Submit” control 124, which when activated submits the information to the server and provides an indication that the submission is going on. Upon completion, window 112 closes, a success indication is optionally provided to the user, and content is added as a post to area 104. Depending on the forum policy, the response can be displayed as an independent post as the latest post in the forum, indented under original post 108 which is moved to be the top most post, indented under original post 108 which is left at the same location, or the like.

Window 112 also comprises an Entire Discussion control 126, which when activated shows in area 116 the whole discussion thread of post 108. In some embodiments, the whole discussion or portions thereof will be displayed in the initial window without the user having to perform any action.

Window 112 further comprises a Close control 128, for closing the window without submitting the response. In some embodiments, Close control 128 is placed at the area of window 112 closest to forum area 104, so that if a user is not interested in answering, or he accidentally placed his mouse over the item, he can easily close the window.

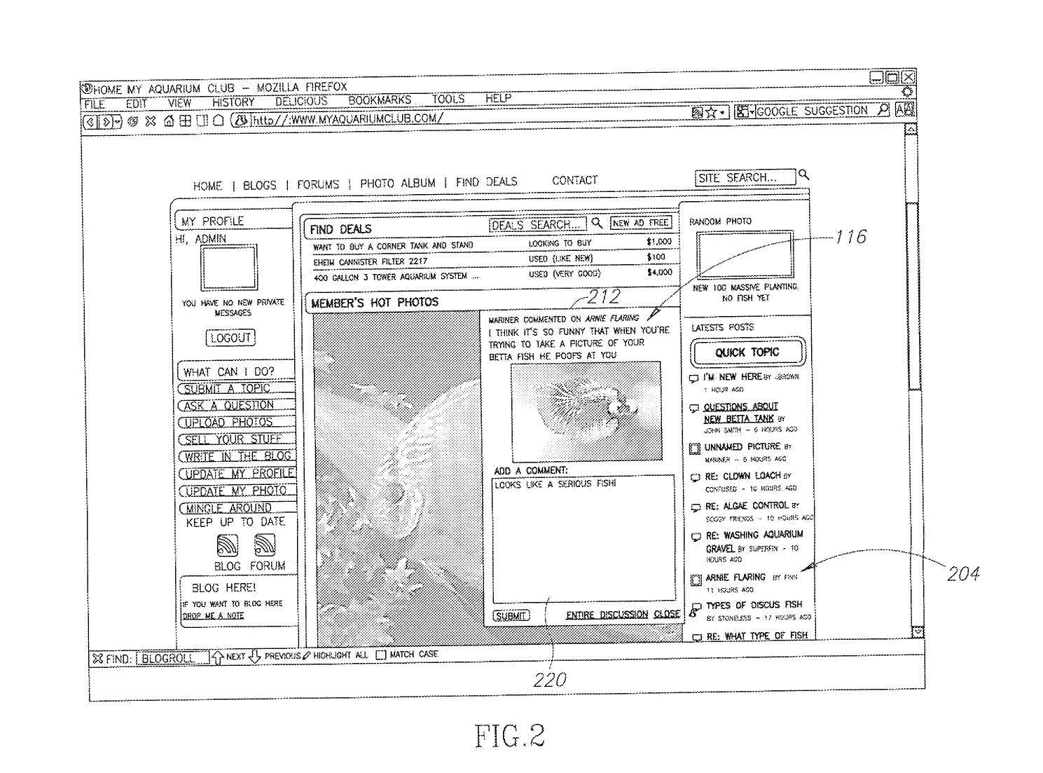

Referring now to FIG. 2, showing a schematic illustration of another screen shot of a web page comprising a forum or a virtual community site, in accordance with the disclosure. Window 212, similarly to window 112 of FIG. 1, was opened when a user hovered over an uploaded picture 204. Window 212 enables the user to comment on picture 204. Window 212 comprises area 216 showing a preview, such as a smaller version, or a version with lower resolution of uploaded picture 204, and optionally text entered by the user who uploaded the picture. Similarly, window 202 can contain and display any other content, such as video.

Window 212 also comprises area 220 for the user to enter content of any type, such as a comment on the picture, another picture, or the like. In a similar manner, a user can hover over blog posts, see a preview of the post and leave a comment; hover over other comments to blog posts, see the comments and add his own comment; hover over other comments to uploaded pictures or videos and add his own comment; hover over pictures, names or nicknames of other users, and send them messages via e-mail, PM, chat, online messaging systems or any other technology, or post user related information, such as signing on users' guest books, etc; hover over products or services and input a review or comment about them; hover over any part of the screen, such as over a flag indication over a displayed map, items of a list, or the like and provide a review or comment about them; hover over a report and provide a comment, note, approval, refusal or the like about specific entries; or others.

As discussed above, window 112 of FIG. 1 or window 212 of FIG. 2 is optionally sized and placed so that no other post separates between the window and the post upon which it was opened. In addition, the window should not hide important parts of the screen or other hover-event triggering items so that the user can keep browsing and viewing or previewing the items. Additionally, the window should not exceed the screen boundaries, and be movable.

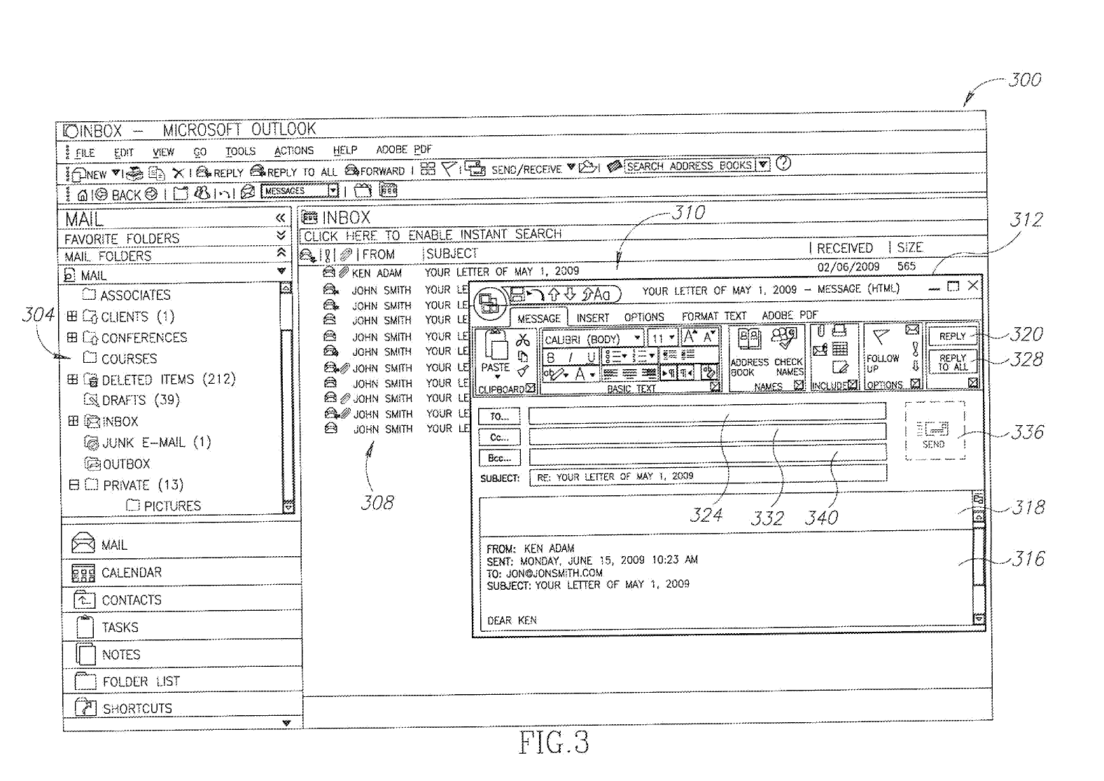

Referring now to FIG. 3, showing a schematic illustration of an e-mail application. The application user interface, generally referenced 300 comprises area 304 showing a folder list, and area 308 showing a list of all e-mails in the folder currently selected in list 304. When the user hovers over a particular e-mail message of list 308, such as message 310, window 312 pops up. Window 312 has the same or a similar subject as the title of message 310, area 316 comprising the full contents of message 310, and area 318 for the user to insert content such as text, pictures, or the like. When window 312 initially pops up, the focus is in area 318, so that the user can immediately start entering content.

Window 312 comprises a “Reply” button 320, which adds the name of the sender of message 310 to “To” field 324, and optionally sends the message, and “Reply to all” button 328, which adds the name of the sender and all recipients of message 310 to “To” field 324, and the names of all CC recipients of message 310 to “Cc” Field 332.

Window 332 also comprises “Send” button 336, which is enabled once at least one recipient is added to “To” field 324, “Cc” field 332, or “Bee” field 340.

If the user moves the mouse or another pointing device outside the boundaries of window 312 and hovers over another message of area 308, or another hover-event triggering item before he or she entered any text into area 318, the window closes, window 312 closes and another window opens for the other item. Alternatively, if the user indicates he wishes to close window 312 using a close button, the window will close. If the user already entered content in area 318, the system will suggest to save the message as a draft or otherwise avoid data loss. In yet another alternative, the window may close once the user moved the mouse outside the window boundaries.

Window 312 is optionally fully contained within the display area, and is movable, for example by dragging. Another preference is that window 312 is sized and placed so that no other e-mail of area 308 separates between window 312 and e-mail 310 upon which it was opened. In addition, the window should not hide important parts of the screen or other e-mails so that the user can keep browsing and viewing or previewing the e-mails.

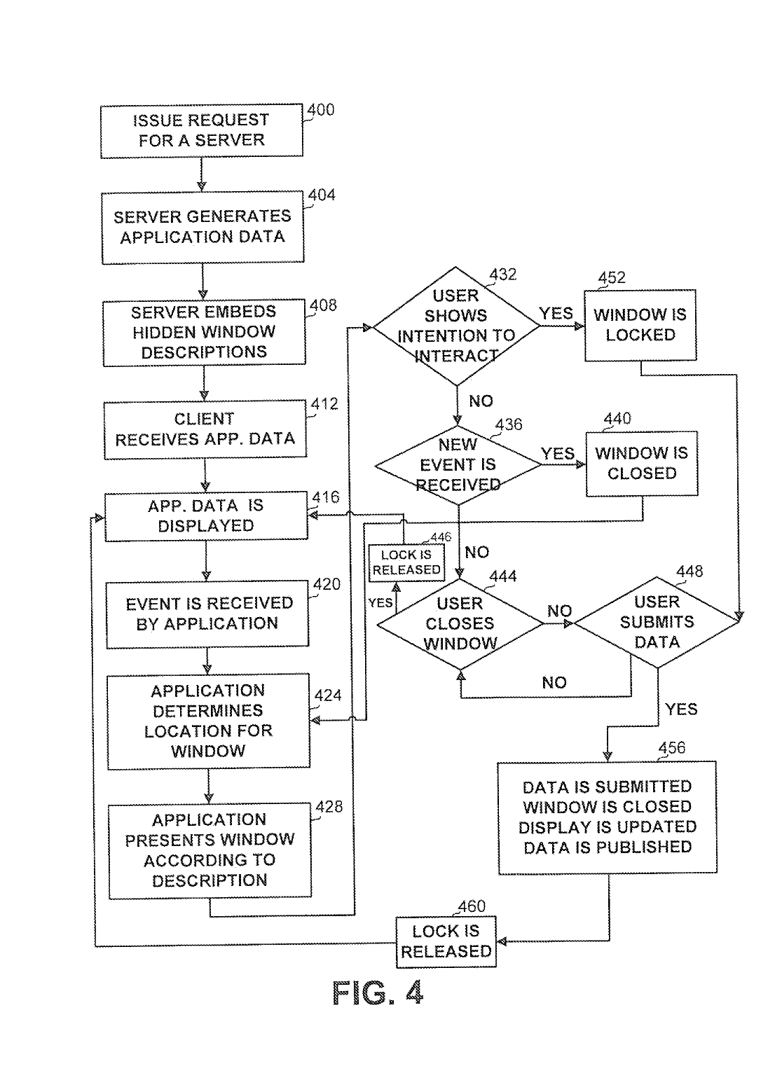

FIG. 4 is a flow chart of the main steps in a method for providing a user interface which enables a user to respond to multiple items. FIG. 4 relates to a web application enabling this functionality. However, the functionality of opening a window which presents the content of an item the user hovered over and enables responding, commenting or adding notes to the item, may be implemented in any other applications, such as e-mail, web application, business application financial application or others.

On step 400 a client, such as a client application in a client-server environment, for example a web browser, issues a request to a server to load required information, such as a web page.

On step 404 the server prepares or generates the information as required, such as a web page in a web application, a list of folders and e-mails for the default folder in an e-mail application, or the like.

On step 408, the server adds to the prepared information, additional data such as a prepared hidden window or a description of a window, which contains full or partial contents of each item on which the user can comment, as well as an area for the user to add content. For example, in a web page comprising a forum, the server may add to each post title in the forum which is displayed to the user, a hidden window that contains the content of the post and a pane for the user to comment. In an e-mail application, a window description may be created for each e-mail message in the current folder, the description comprising the content of the message, and an area for a user to add data. The window descriptions are “hidden”, i.e., they are not displayed together with the regular page or data. The window may relate to the particular application the user is operating, or to another application, such as an e-mail message to be sent to an author of a post.

On step 412 the client receives the application data and the additional information from the server, and on step 416 the client displays the application data, without displaying the window descriptions added on step 408.

On step 420, a mouse over event is fired when the pointing device hovers over an item such as a forum post or an e-mail. The event is received by the application.

On step 424 the application, by either the server side or the client side determines a location for a window associated with the item, in accordance with the considerations as detailed in association with FIG. 2 and FIG. 3 above. The server side may provide the location as part of embedding the hidden window description on step 408. The window may be displayed such that its focus is in the area at which the user can enter content, so if the user wishes to add content, no additional mouse click or another indication is required.

On step 428 the client-side application displays the window in accordance with the description as received from the server. The window presents an area for the user to enter data, optionally a title, and optionally a few buttons as detailed in FIG. 1, 2 or 3 above. The window optionally presents also the content of the item over which the pointing device hovered, if such content is available. For example if the window is opened after hovering on a “new message”, window, then no content is available. For popping up such a window, the application can comprise a script which reads the “hidden” added data from the description provided by the server, or any third-party tool, such as overLib developed by Erik Bosrup and available at http://www.bosrup.com/web/overlib/?Download. overLib is a JavaScript library designed to enhance websites with popup information boxes like tooltips.

Since the window to be displayed is prepared a-priori by the server, no preparation is required before it can be displayed, so that the presentation is very efficient and the window is popped up without the user having to wait.

However, in some embodiments, the server can pre-prepare only a portion of the additional. Then the client will request the rest of the preview or the entire item on the actual mouse hover event. The client will then embed the data when it gets it. For example, the server may prepare a window with the last 3 posts of each thread, and when the window is shown, the entire thread is requested and embedded within the window. The user may not even notice, since only the scroll bar of the window will change). This implementation is useful when many items are available for a preview, of which statistically, only few will actually be viewed.

In addition, in some alternative embodiments, the server may produce only some of the additional data, while other parts such as the window title, may be produced by the client application after receiving the mouse over event. This implementation may be useful in environments in which the client application is executed by a computing platform with significant processing resources, when the server application serves many connections and is highly loaded, or when the communication bandwidth between the client and the server are insufficient.

On step 432 it is determined whether the user shows an intention to interact with the window, for example by clicking the mouse in the data entering area, by dragging the window to another location, typing text, or the like. This step is performed continuously, until such intention is detected, or until a new relevant event, such as mouse hover, close or submit event is received on step 436.

If on step 436 it is determined that a new event is received, then on step 440 the window is closed, and the method returns to step 424 and determines the location for the new window to be displayed.

If no new mouse hover event is received, then if it is determined on step 444 that the user wishes to close the window. If yes, then on step 446 the lock on the window is released, the window is closed and the method continues to display the page or application data on step 416.

If no, then is determined on step 448 whether the user wishes to submit the entered data. If no, step 444 and 448 repeat until the user wishes to close the window or submit the information.

If on step 432 the user indicated he wishes to indicate with the window, then on step 452 the window is locked, i.e., it will not be closed due to a mouse hover event associated with another item nor will a new window pop up. When the window is locked, it is determined on step 448 whether the user wishes to submit the entered data.

When the user wishes to submit the data, i.e. make it available for publishing so that a human being can consume it, then on step 456 the content the user entered into the window will be submitted to the application by sending a relevant command to the server, in the same manner as ordinary data addition in accordance with the executed application. Alternatively, the data may be submitted to another application. For example, if the opened window is an e-mail message opened from a virtual community application, then the data is submitted to the e-mail program and not to the virtual community application. Also on step 456 the window is closed, and display is updated, without the user having to refresh the display. The data is optionally published in the manner relevant to the target application. On step 460 the lock on the window is released.

The disclosed method thus enables a user to browse through multiple items without having to perform any action such as a mouse click for opening a dedicated window in order to view an item. Further, if the user does not want to reply or comment on the item, he can simply hover over another item and view the other item without any further mouse click or a similar action.

However, if the user does wish to comment or reply on any item, he can add content without any further window activation. If the focus of the window is automatically set to be in the data entering area, the user can start typing or otherwise entering content without any mouse clicks. Moreover, the data preview and optionally content entering are performed without any page loads or context changes.

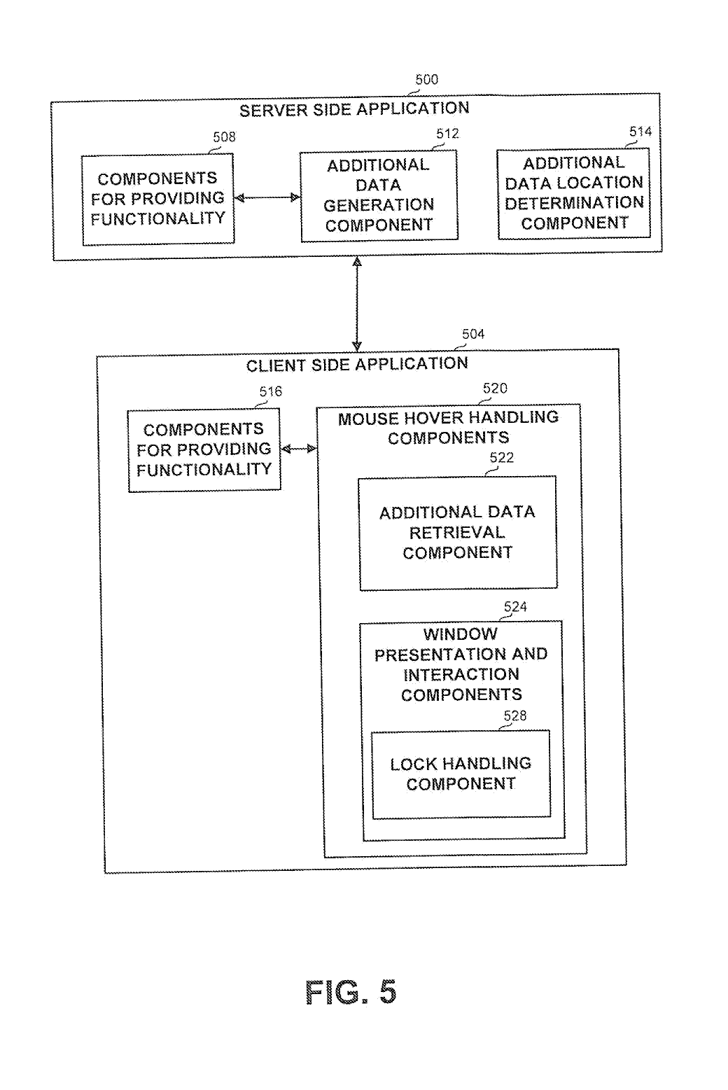

Referring now to FIG. 5, showing a block diagram of an apparatus for enabling a user to respond to multiple items, in accordance with the disclosure.

The apparatus is optionally a client-server application in which a client computing platform used by a user executes a client application, and communicates with a server computing platform that executes a server application. Each of the client and server applications is executed by a computing platform, such as a general purpose computer, a server, a personal computer, a mainframe computer, a mobile device, or any other type of computing platform provisioned with a memory device, a CPU or microprocessor device, and I/O ports.

The client and server computing platforms can communicate via any wired or wireless communication media, such as RF, a local area network, a wide area network, the Internet, Intra-net, telephone network, voice over IP and the like, employing commonly used protocols such as TCP, IP, IPTV or derivatives thereof.

The client and server applications executed by the computing platforms are implemented as one or more sets of interrelated computer instructions, such as an executable, static library, Dynamic Link Library (DLL), class library, web service, web page, or the like. The applications can be implemented in any programming language such as Java, C#, C++, or others, and under any development environment.

Alternatively, the apparatus can be implemented as firmware ported for a specific processor such as digital signal processor (DSP) or microcontrollers, or can be implemented as hardware or configurable hardware such as field programmable gate array (FPGA) or application specific integrated circuit (ASIC).

Thus, an apparatus comprises a server side application 500 executed by a server computing platform, and a client side application 504 executed by a client computing platform.

Server side application 500 comprises components 508 for providing the functionality of the server application, such as e-mail server, portal, forum, a financial service, or any other.

Server side application 500 further comprises additional data generation component 512 for generating the additional data, such as the description of the additional windows, each associated with one of the items displayed by the application, which may popup when the mouse or another pointing device hovers over the items.

Server side application 500 further comprises additional data location determination component 514, for determining the location and optionally the size of the window or pane presented when the mouse hovers over an item. The window location is determined based on the considerations detailed above. It will be appreciated that the location determination component can alternatively be implemented as part of the client side application.

Client side application 504 comprises components 516 for providing the functionality of the client application, such as e-mail client, web browser, a service-consuming application, or the like.

Client side application 504 further comprises mouse hover handling components 520, for providing the options of efficient browsing and responding to items.

Mouse hover handling components 520 may comprise additional data retrieval component 522, for retrieving the data required for the window from the application data, as embedded by the server. In some embodiments, the server can embed only part of the data in the window description, such as only the last predetermined number of posts. In such embodiments, additional data retrieval component 522 can also request the rest of the thread once the window is displayed.

Mouse hover handling components 520 further comprise window presentation and handling components 524 for receiving the mouse hover event, presenting the window with the data retrieved by additional data retrieval component 522, and handling the window's functionality, as described in steps 428 and the following steps of FIG. 4 above.

Window presentation and handling components 524 may comprise, or otherwise interact with lock handling components 528 responsible for managing the window lock and unlock mechanisms.

Client side application 504 may comprise a further component or a product such as overLib designed to display the window with the required information.

In some embodiments, the apparatus can be implemented as a stand-alone application, as opposed to a client-server application. In a stand-alone embodiment, no communication with another computing platform is required. In such embodiments, functionality providing components 508 and 516 are unified into a, single set of components providing the required functionality, and components 512 and 520 are also implemented as part of the application.

The disclosed method and apparatus provide an easy and efficient way for using applications. By just moving the pointing device around, the user is presented with a preview or with the full information of each item displayed by an application.

It will be appreciated that the applications may include but are not limited to: forums, discussion groups, or online discussion services in which a user may post new messages or reply to existing posts; video, audio, or photo uploading or sharing platforms, in which a user can post video or images, or provide comments or reviews on items; blogs in which a user can post blog posts or messages, or comment on items; file sharing applications, in which a user can share applications or provide comments or reviews on applications posted by others; email applications; social bookmarking applications in which a user can add new comments, share, or bookmark new items; bookmarking applications; directory applications in which a user can comment on items on a directory; a search engine or a search service providing search results, for which a user can provide comments or bookmark items; map applications in which a user can provide comments on locations, pictures, notes or other items; diagrams in which a user can provide comments on elements; travel applications, in which a user can provide reviews or comments, or make a booking; retail or shopping applications, in which a user can provide product reviews or comments, or make a purchase; price comparison or other marketplace applications in which a user can provide product reviews, comments, or seller reviews, or make a purchase; product review applications in which a user can provide product reviews or make a purchase; educational applications in which a user can provide notes on items; telecomm applications; business applications; financial applications; reporting applications or activity record applications in which a user can provide notes, questions, or comments on items; a Customer Relationship Management (CRM) or an Enterprise Resource Planning (ERP) applications in which a user can provide notes, questions, or comments on items; news items applications in which a user can provide talkbacks, notes or bookmark items; data feed handling applications, in which a user can provide notes or bookmark items, or any other application. The user does not have to determine in advance whether he would like to reply comment, or otherwise relate to any of the items, and does not have to perform any additional operation before doing so. The user can just start adding information once the item is presented, using a dedicated data entering area.

The data added by the user may later be viewed by human beings, including the user himself, or any other person, such as a recipient of an e-mail, another subscriber to a blog, a viewer of an article with talkbacks, or the like.

Trials in real-life environments proved a significant increase in the volume of data entered by users using an internet forum employing the disclosed method and apparatus, as compared to the volume entered into the same forum prior to employing the method and apparatus. The users also provided positive feedback and reported high levels of surprise and contentment with the new interface.

It will be appreciated that the disclosure is not limited to be used in the listed exemplary applications, but can also be used with any other application. The method and apparatus can also be used with applications having multiple types of items, such as a portal showing a forum on one part of the screen, and an article with talkbacks in another part. It will be appreciated that although the description related to a mouse hover event, the method and apparatus can be activated by other events as well, including mouse over, mouse down, mouse up or others, and also by events not related to a pointing device.

It will be appreciated by a person skilled in the art that the disclosed apparatus is exemplary only and that multiple other implementations can be designed without deviating from the disclosure. Any component of the apparatus can be implemented using proprietary, commercial or third party product.

It will be appreciated by persons skilled in the art that the present disclosure is not limited to what has been particularly shown and described hereinabove. Rather the scope of the present disclosure is defined only by the claims which follow.

What is claimed is:

1. A method for receiving information from a user of a computerized application, comprising:
receiving application data comprising at least one item to which a user can react;
receiving additional data relating to the application;
displaying on a display device the application data to a user using a pointing device;
receiving an event indicating that the pointing device hovered over one of the at least one item;
displaying on the display device a display container displaying the additional data relating to the at least one item, and an area for a user to enter content; and
submitting the content entered by the user.

2. The method of claim 1 further comprising a step of publishing the information submitted by the user.

3. The method of claim 1 wherein the content provided by the user is viewable by a human being.

4. The method of claim 1 further comprising determination of a location in which the display container is placed on the display device.

5. The method of claim 1 wherein the location is determined in accordance with at least one of the conditions selected from the group consisting of: no other item that invokes a hover event separates the at least one item and the display container, the display container does not hide another item that invokes a hover event, the display container does not hide an important area of the application, and the display container is fully contained within the display device.

6. The method of claim 1 wherein the location is determined so that the additional data is fully viewable by the user.

7. The method of claim 1 further comprising locking the display container so that no further events indicating that the pointing device hovered over one of the at least one item is handled.

8. The method of claim 1 wherein the additional data comprises at least part of the contents of the at least one item.

9. The method of claim 1 further comprising generating the application data.

10. The method of claim 1 further comprising generating the additional data.

11. The method of claim 1 wherein the application is selected from the group consisting of: a forum, a discussion group or an online discussion service; a video, audio or photo uploading or sharing platform; a blog; a file sharing application; a social bookmarking applications, an e-mail application; a bookmarking application; a directory application, a search engine or a search service; a map application; a diagrams; a travel application; a retail or shopping application; a price comparison or marketplace application; a product review application; an educational application; a telecomm application; a business application; a financial application; a reporting application; an activity record application; a Customer Relationship Management (CRM) application; an Enterprise Resource Planning (ERP) application; a news item application; and a data feed handling application.

12. The method of claim 1 wherein the additional data is embedded and hidden within the application data.

13. An apparatus for receiving information from a user of a computerized application executed on a computing platform, comprising:
a functionality providing component for providing application data and functionality associated with at least one item to which a user of the application can react;
an additional data generation component for generating additional data related to the application and adding the additional data to the application data; and
a window location determination component for determining a location on the display device at which a display container displaying the additional data and having an area for the user to enter content, is to be located.

14. The apparatus of claim 13 further comprising an additional data presentation component for displaying the display container on a display device, when a pointing device hovers over the at least one item.

15. The apparatus of claim 13 wherein the application is a client-server application, and wherein the server-side application comprises an additional data generation component for generating additional data related to the at least one item and adding the additional data to the application data; and the client-side application comprises an additional data retrieval component for retrieving the additional data from the application data.

16. The apparatus of claim 13 wherein the content provided by the user is published.

17. The apparatus of claim 13 wherein the content provided by the user is viewable by a human being.

18. The apparatus of claim 13 wherein the additional data comprises at least part of the contents of the at least one item.

19. The apparatus of claim 13 wherein the application is selected from the group consisting of: a forum, a discussion group or an online discussion service; a video, audio or photo uploading or sharing platform; a blog; a file sharing application; a social bookmarking applications, an e-mail application; a bookmarking application; a directory application, a search engine or a search service; a map application; a diagrams; a travel application; a retail or shopping application; a price comparison or marketplace application; a product review application; an educational application; a telecomm application; a business application; a financial application; a reporting application; an activity record application; a Customer Relationship Management (CRM) application; an Enterprise Resource Planning (ERP) application; a news item application; and a data feed handling application.

20. A tangible computer readable storage medium containing a set of instructions for a general purpose computer, the set of instructions comprising:
receiving application data relating to an application comprising at least one item to which a user can react;
receiving additional data relating to the at least one item;
displaying on a display device the application data to a user using a pointing device;
receiving an event indicating that the pointing device hovered over one of the at least one item;
displaying on the display device a display container displaying the additional data relating to the application, and an area for a user to enter content; and
updating the application with the information entered by the user.
